(19) United States
(12) Patent Application Publication
(10) Pub. No.: US 2024/0246845 A1
(43) Pub. Date: Jul. 25, 2024

(54) SCALE INHIBITOR COMPOSITIONS AND METHODS WITH SUPRAMOLECULAR STRUCTURES

(71) Applicant: BPS JUST ENERGY TECHNOLOGY, LLC, Argyle, TX (US)

(72) Inventors: Jason L. HURST, Roanoke, TX (US); Patrick Jordan LARSON, Fort Worth, TX (US); Donna Jean SHOTWELL, Eufaula, OK (US); Robert GEIGER, Lantana, TX (US)

(21) Appl. No.: 18/563,589

(22) PCT Filed: May 26, 2022
(86) PCT No.: PCT/US22/31065

§ 371 Date: Nov. 22, 2023

Related U.S. Application Data
(60) Provisional application No. 63/193,225, filed on May 26, 2021.

(51) Int. Cl. C02F 5/14; C02F 5/10

(52) U.S. Cl. CPC C02F 5/14; C02F 5/105

(57) ABSTRACT

Compositions with supramolecular structures for use in anti-scaling methods include a scale inhibitor; a supramolecular host chemical or a supramolecular guest chemical configured to engage in host-guest chemistry with the scale inhibitor; and a solvent. Methods of inhibiting scale formation on a surface or reducing the amount of scale inhibitor composition within a system include adding an anti-scale inhibiting amount of the composition to the system.

### FIELD OF THE INVENTION

The present disclosure relates to scale inhibitor compositions that include a scale inhibitor having supramolecular structures that increase the activity of the scale inhibitor, and methods of using the scale inhibitor compositions to inhibit scale formation or reduce the amount of scale inhibitor needed to prevent scale formation.

### BACKGROUND OF THE DISCLOSURE

Scale inhibitors have importance as individual inhibitors and as a component in chemical formulations. Scale inhibitors are extensively used worldwide in a variety of applications to minimize the rate of scale deposition on various surfaces subjected to any specific environment. With increased and repeated use of scale inhibitors, there has been a large concern with sustainability and effectiveness. A wide assortment of active chemical agents is found in these products, and of the currently active chemicals that are utilized in this area, many have been used for hundreds of years.

Considerable progress has been made in understanding the mechanisms of scale and the methods used to apply protective inhibitors. The advancement in discovery applies to aqueous-based inhibitors for treatment of most water-based fluids. The emphasis over the last few decades has been on the improvement of inhibition technology where most common inhibitors are used in industrial water systems, oil and gas, agriculture, and common household facilities. However, this developmental process for specific inhibitors in specific environments takes considerable time and often requires a lengthy and costly research and development process.

Even though these techniques overcome different and difficult situations, there has been a growing concern on increasing the effectiveness of scale inhibitors with approved active chemicals, particularly while minimizing the environmental impacts of manmade chemicals. Accordingly, improved compositions and methods are needed to boost the scale activity of currently approved scale inhibitors.

### BRIEF DESCRIPTION OF THE DRAWINGS

The present disclosure is best understood from the following detailed description when read with the accompanying figures.

FIG. 1 is a graph showing the calcium scaling rates of Composition A in Example 1 according to aspects of the present disclosure.

FIG. 2 is a graph showing the calcium scaling rates of Composition B in Example 2 according to aspects of the present disclosure.

FIG. 3 is a graph showing the calcium scaling rates of Compositions C and D in Example 3 according to aspects of the present disclosure.

FIG. 4 is a graph showing the strontium scaling rates of Compositions A-D in Example 4 according to aspects of the present disclosure.

FIG. 5 is a graph showing the average reduction in calcium and strontium scaling rates of Compositions A-D in Examples 1-4 according to aspects of the present disclosure.

### DETAILED DESCRIPTION OF THE PREFERRED EMBODIMENTS

The present disclosure is directed to scale inhibitor compositions having increased anti-scaling efficiency, which without being bound by theory is believed to be due to by the formation of supramolecular structures. As used herein, a “scale inhibitor” refers to (1) a chemical compound, where the compound, when added to a fluid (such as an aqueous system), reduces or inhibits the amount of scale formation, adherence, or both, on a surface material, typically a metal or an alloy, fiber glass, or a polysurface, that directly or indirectly comes into contact with the fluid, and/or (2) a chemical compound that, when applied to a surface material, decreases the amount of scale formation on the surface material when in contact with a fluid. “Scale” refers to insoluble substances, such as insoluble salts, that have a tendency to form in fluids such as boiler water, cooling water, seawater (e.g., in oil platform applications), brackish water, oilfield water, municipal treatment plant water, paper mill water, mining water, and industrial treatment plant water. Examples of scale include calcium carbonate, barium sulfate, strontium sulfate, calcium sulfate dehydrate, sodium chloride, calcium fluorite, zinc sulfide, lead sulfide, magnesium carbonate, sodium carbonate, magnesium and sodium nitrates, silica, and combinations of the foregoing. Advantageously, different chemistries mixed with supramolecular structures have been found to increase the activity of common scale inhibitors, while minimizing the environmental impact by reduction of the amount of raw material required, e.g., less scale inhibitor may be used while achieving the same anti-scaling effect.

In certain embodiments, the scale inhibitor compositions include: (1) a scale inhibitor; (2) a supramolecular host or guest chemical configured to engage in host-guest chemistry with the scale inhibitor; and (3) a solvent, such as water, an alcohol, a glycol, or an oil. In some embodiments, one or more formulation additives, such as pH buffers, colorants, adjuvants, stabilizers, or rheology modifiers are included in the scale inhibitor compositions, and any suitable type and amount of each additive, in any combination, may be used in the present scale inhibitor compositions based on the guidance provided herein. Particularly suitable pH buffers or neutralizers include, for example, citric acid, phosphate buffers, sodium hydroxide, and hydrochloric acid. Any kind of dye or pigment may serve as the colorant, if included. Suitable adjuvants include all kinds of surfactants that are used to spread, stick onto, or penetrate different types of surfaces to facilitate spread, adhesion, or penetration of a scale inhibitor composition to or into a surface material. Suitable rheology modifiers include, for example, one or more guar gums, xanthan gum, celluloses, carbomers, and cross-linked polymers. Any kind of additive may be included in the scale inhibitor compositions to facilitate the efficacy thereof or otherwise beneficially affect the properties thereof, as long as it does not significantly interfere with the anti-scale action of the scale inhibitor. Advantageously, the supramolecular host or guest chemical forms supramolecular structures with the scale inhibitor.

In various embodiments, the scale inhibitor in the scale inhibitor composition includes an organic scale inhibitor. The organic scale inhibitor may be selected from, for example, polyacrylic acid (PAA), phosphino carboxylic acid, sulfonated polymers, phosphonates, phosphate esters, and any combination thereof. In some alternative embodiments, the scale inhibitor in the scale inhibitor composition includes an inorganic scale inhibitor. The inorganic scale inhibitor may be selected from a condensed phosphate, such as poly(metaphosphate)s or phosphate salts. In certain embodiments, the scale inhibitor is mixed with other additives. The scale inhibitor may include both an organic and an inorganic scale inhibitor, as well.

In an exemplary embodiment, the scale inhibitors of this disclosure are used to prevent, inhibit, reduce, or otherwise control the effects of scale on a surface material. Suitable scale inhibitors include, but are not limited to, 2-phosphonobutane-1,2,4-tricarboxylic acid (PBTC); 1-hydroxyethane 1,1-diphosphonic acid (HEDP); nitrilotris(methylene phosphonic acid) (NTMP); ethylenediamine tetra(methylene phosphonic acid) (EDTMP): sodium iminodisuccinate; polycarboxylate, sodium salt; acrylic polymers; diethylenetriamine penta (methylene phosphonic acid) (DTPMP); polycarboxylate; 2-propenoic acid, telomer with sodium 2-methyl-2-[(1-oxo-2-propen-1-yl)amino]-1-propanesulfonate (1:1) and sodium phosphinite (1:1); and triethanolamine phosphonate. Combinations of these or other scale inhibitors may be used in the compositions and methods of the present disclosure. One of ordinary skill in the art recognizes that these types of scale inhibitors are merely exemplary, and that this list is neither exclusive nor limiting to the compositions and methods described herein.

In certain embodiments, the scale inhibitor is present in an amount of about 1 percent to about 90 percent by weight of the scale inhibitor composition, for example about 25 percent to about 75 percent by weight of the scale inhibitor composition or about 30 percent to about 70 percent by weight of the scale inhibitor composition. In some preferred embodiments, the scale inhibitor is present in an amount of about 5 percent to about 35 percent by weight, and preferably about 10 to about 30 percent by weight, of the scale inhibitor composition.

In selecting suitable supramolecular host or guest chemical(s), (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with a solvent. A preferred solvent includes an aqueous solvent, such as water.

Host chemicals may include a charge, may have magnetic properties, or both. Host chemicals may be soluble or insoluble in the solvent system. If insoluble in the solvent, the particle size of the host chemical is typically greater than 100 nanometers, and the host chemical does not include nanoparticles or nanostructures. Suitable supramolecular host chemicals include cavitands, cryptands, rotaxanes, catenanes, minerals (e.g., clays, silica, or silicates), or any combination thereof.

Cavitands are container-shaped molecules that can engage in host-guest chemistry with guest molecules of a complementary shape and size. Examples of cavitands include cyclodextrins, calixarenes, pillarrenes, and cucurbiturils. Calixarenes are cyclic oligomers, which may be obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH2]₃N or 1,10-diaza-4,7,13,16,21,24-hexaoxabicyclo[8.8.8]hexacosane. Cryptands form complexes with many cations, including NH₄⁺, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another, but cannot be separated unless covalent bond breakage occurs.

Suitable supramolecular guest chemicals include cyanuric acid, minerals (e.g., clays, silica, or silicates), water, and melamine, and are preferably selected from cyanuric acid or melamine, or a combination thereof. Guest chemicals may have a charge, may have magnetic properties, or both. Guest chemicals may be soluble or insoluble in the solvent system. If the guest chemical is insoluble in the solvent, the particle size is generally greater than 100 nanometers, and the guest chemical is not in the form of nanoparticles or nanostructures.

The supramolecular host chemical or the supramolecular guest chemical is present in the scale inhibitor composition in any suitable amount but is generally present in the scale inhibitor composition in an amount of about 1 percent to about 90 percent by weight of the scale inhibitor composition. In certain embodiments, the supramolecular host chemical or supramolecular guest chemical, or host and guest chemical combination, is present in an amount of about 10 percent to about 80 percent by weight of the scale inhibitor composition, for example, 10 percent to about 50 percent by weight of the scale inhibitor composition.

Any aqueous or non-aqueous solvent may be used, including for example water, an alcohol, a glycol, or an oil. Typically, an aqueous solvent is used, and water is used as a preferred aqueous solvent. The solvent is typically present in an amount that is at least sufficient to dissolve any solid components partially and preferably substantially in the scale inhibitor composition. Water (or other polar solvent) is present in any suitable amount but is generally present in the scale inhibitor composition in an amount of about 0.5 percent to about 80 percent by weight of the scale inhibitor composition. In certain embodiments, water is present in an amount of about 5 percent to about 78 percent by weight of the scale inhibitor composition, for example, 50 percent to about 75 percent by weight of the scale inhibitor composition. In various embodiments, the solvent partially dissolves one more components of the scale inhibitor composition. In some embodiments, the solvent is selected to at least substantially dissolve (e.g., dissolve at least 90%, preferably at least about 95%, and more preferably at least about 99% or 99.9%, of all the components) or completely dissolve all of the components of the scale inhibitor composition.

The order of addition of the components of the scale inhibitor composition can be important to obtain stable supramolecular structures or assemblies in the final mixture. The order of addition is typically: (1) a solvent, (2) any additives, (3) a scale inhibitor; and (4) a supramolecular host chemical or a supramolecular guest chemical. Once these components are fully mixed, supramolecular structures can be formed that provide the synergistic anti-scale benefits described herein.

The scale inhibitor compositions can be applied to a surface or added to a fluid in any suitable manner to inhibit the formation of scale on a surface material where constant contact with a fluid or aqueous system is present. In some embodiments, a fluid is provided with an anti-scale inhibiting amount of the scale inhibitor composition. In various embodiments, the fluid is dosed at about 2 ppm to about 200 ppm of the scale inhibitor composition, for example at about 10 ppm to about 150 ppm or about 25 ppm to about 100 ppm of the scale inhibitor composition. In several embodiments, the applied scale inhibitor composition inhibits scale formation on a surface material where constant contact with a fluid is present. For example, the rate of scale formation on one or more surface materials may be reduced for a duration of at least about 24 hours. It should be understood, without being bound by theory, that the present scale inhibitor compositions may include reduced amounts of scale inhibitors to achieve the same or better anti-scale effects compared to anti-scale compositions including conventional scale inhibitors (including the same scale inhibitors described herein) that are free or substantially free of a supramolecular host chemical or a supramolecular guest chemical.

As used herein, the term “about” is intended to refer to amounts within 15 percent, and preferably within 10 percent, of the referenced amount and to refer to both numbers in a range. In some preferred embodiments, the term is intended to mean amounts within 5 percent of such number or the endpoints of such a range.

The following examples are illustrative of the compositions and methods discussed above and are not intended to be limiting.

### EXAMPLES

### Scale Inhibitors and Brines for Scale Screening

The three scale inhibitors provided in Table 1 were tested and formulated into compositions for testing.

TABLE 1
SCALE INHIBITORS TESTED

| Product | | | |
|---|---|---|---|
| Name | Supplier | Chemical Composition | Label |
| ACCENT ™ | DOW | Polycarboxylate, sodium | Active |
| Scale | CHEMICAL | salt | A |
| Inhibitor | | | |
| 1102 | | | |
| Mayoquest ® | ITALMATCH | Diethylenetriamine Penta | Active |
| 1860 SG | CHEMICALS | (methylene phosphonic acid) | B |
| | GROUP | Hydrochloric/Phosphoric acid | |
| | | mixture | |
| SI-193C | ITALMATCH | Triethanolamine Phosphate | Active |
| | CHEMICALS | Ester | C |
| | GROUP | | |

A synthetic salt brine was used to accelerate scale formation during the scale study by preparing a 2-part solution using the brines provided in Tables 2-4 (modified from Gandhi R. Osorio-Celestino et al., Influence of Calcium Scaling on Corrosion Behavior of Steel and Aluminum Alloys. ACS Omega. 2020, May 28, 17304-17313 (https://doi.org/10.1021/acsomega.0c01538).

TABLE 2
BRINE A

| | Percent |
|---|---|
| Component | (w/w) |
| Magnesium Chloride | 2.11% |
| Sodium Chloride | 5.27% |
| Sodium Sulfate | 2.55% |
| Sodium Bicarbonate | 1.66% |
| Deionized Water | 88.41% |

TABLE 3
BRINE B

| | Percent |
|---|---|
| Component | (w/w) |
| Calcium Chloride | 2.55% |
| Deionized Water | 97.45% |

TABLE 4
BRINE C

| | Percent |
|---|---|
| Component | (w/w) |
| Strontium Chloride | 4.62% |
| Deionized Water | 95.38% |

### Example 1: Scale Screening for Composition A

A solution of active A (20% w/w) was prepared using deionized water. This solution served as Control Composition A. Another solution of active A (20% w/w) was prepared with deionized water and a supramolecular host chemical (10% w/w) (SymMAX™ supramolecular host or guest water mixture commercially available from Shotwell Hydrogenics, LLC or BPS Shotwell). This solution served as Composition A.

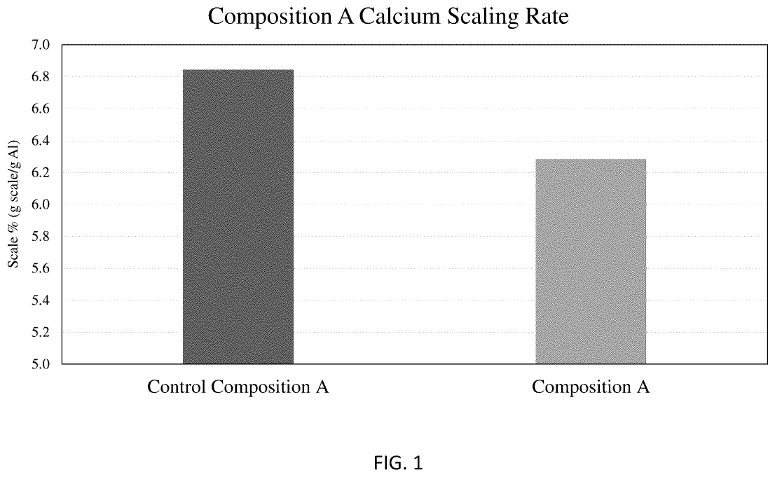

Composition A was introduced at 25 ppm to a 50/50 solution of Brine A and Brine B. Scale testing was completed by suspending two 2″×1″ aluminum 3003-H14 coupons, fabricated from material acquired from McMaster-Carr Supply, into the 50/50 solution with Composition A. Sample containers were then placed into a laboratory oven at an elevated temperature of 150° C. and continuously monitored with a thermocouple until the sample temperature reached 90° C. Once the desired temperature was reached, the samples were removed from the oven and allowed to return to ambient temperature. The coupons were then removed, lightly rinsed, and then allowed to dry in a laboratory incubator for 4 hours. After 4 hours, a final weight was captured and compared against initial weight to determine the amount of scale precipitated onto the coupon surface. The total scaling was measured by comparing initial weight to the final weight of the coupons. Control Composition A was then compared to Composition A, which resulted in an 8.2% reduction in scaling rates as seen in Table 5 below and FIG. 1.

TABLE 5
25 PPM ACTIVE A SCALING RATES

| | |
|---|---|
| Scale % (g scale/g Al*100) | Percentage |

| Composition A | Control Composition A | Difference |
|---|---|---|
| 6.28 | 6.84 | 8.19 |

### Example 2: Scale Screening for Composition B

A solution of active B (20% w/w) was prepared using deionized water. This solution served as Control Composition B. Another solution of active B (20% w/w) was prepared with deionized water and a supramolecular host chemical (75% w/w) (SymMAX™ supramolecular host or guest water mixture commercially available from Shotwell Hydrogenics, LLC or BPS Shotwell). This solution served as Composition B.

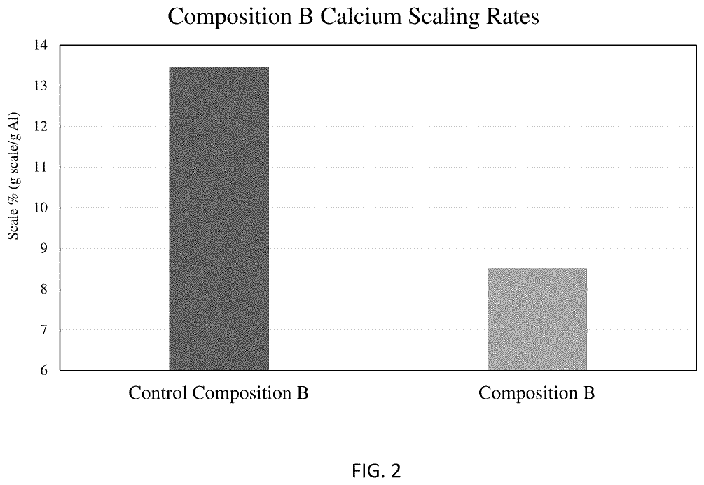

Composition B was introduced at 25 ppm to a 50/50 solution of Brine A and Brine B. Scale testing was completed by suspending two 2″×1″ aluminum 3003-H14 coupons, fabricated from material acquired from McMaster-Carr Supply, into the 50/50 solution with Composition B. Sample containers were then placed into a laboratory oven at an elevated temperature of 150° C. and continuously monitored with a thermocouple until the sample temperature reached 90° C. Once the desired temperature was reached, the samples were removed from the oven and allowed to return to ambient temperature. The coupons were then removed, lightly rinsed, and then allowed to dry in a laboratory incubator for 4 hours. After 4 hours, a final weight was captured and compared against initial weight to determine the amount of scale precipitated onto the coupon surface. The total scaling was measured by comparing initial weight to the final weight of the coupons. Control Composition B was then compared to Composition B, which resulted in an 36.8% reduction in scaling rates as seen in Table 6 below and FIG. 2.

TABLE 6
25 PPM ACTIVE B SCALING RATES

| | |
|---|---|
| Scale % (g scale/g Al*100) | Percentage |

| Composition B | Control Composition B | Difference |
|---|---|---|
| 8.51 | 13.46 | 36.81 |

### Example 3: Scale Screening for Compositions C and D

A solution of active C (20% w/w) was prepared using deionized water. This solution served as Control Composition C. Another solution of active C (20% w/w) was prepared with deionized water and a supramolecular host chemical (5% w/w) (SymMAX™ supramolecular host or guest water mixture commercially available from Shotwell Hydrogenics, LLC or BPS Shotwell). This solution served as Composition C. Yet another solution of active C (20% w/w) was prepared with deionized water and a supramolecular host chemical (1% w/w) (SymMAX™ supramolecular host or guest water mixture commercially available from Shotwell Hydrogenics, LLC or BPS Shotwell). This solution served as Composition D.

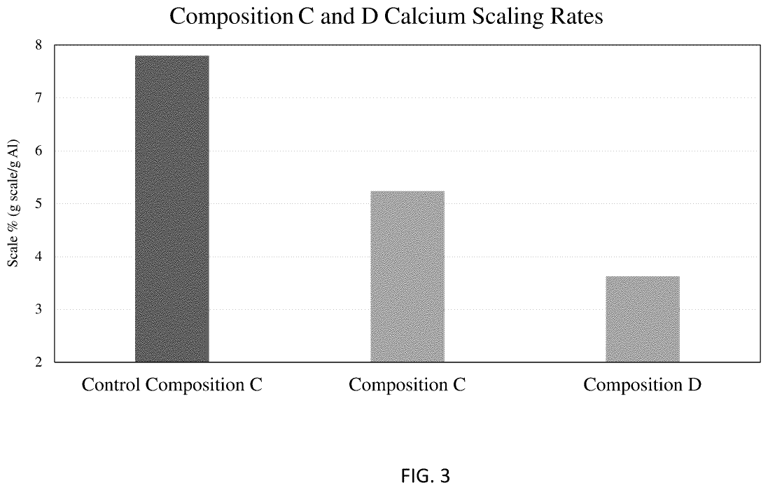

Composition C and Composition D were each introduced at 25 ppm to a 50/50 solution of Brine A and Brine B. Scale testing was completed by suspending two 2″×1″ aluminum 3003-H14 coupons, fabricated from material acquired from McMaster-Carr Supply, into the 50/50 solution with Composition C and into the 50/50 solution with Composition D. Sample containers were then placed into a laboratory oven at an elevated temperature of 150° ° C. and continuously monitored with a thermocouple until the sample temperature reached 90° C. Once the desired temperature was reached, the samples were removed from the oven and allowed to return to ambient temperature. The coupons were then removed, lightly rinsed, and then allowed to dry in a laboratory incubator for 4 hours. After 4 hours, a final weight was captured and compared against initial weight to determine the amount of scale precipitated onto the coupon surface. The total scaling was measured by comparing initial weight to the final weight of the coupons. Control Composition C was then compared to Composition C and Composition D, which resulted in an 32.8% reduction and a 53.5% reduction in scaling rates as seen in Table 7 below and FIG. 3.

TABLE 7
25 PPM ACTIVE C SCALING RATES

Scale % (g scale/g Al*100)

| | | Control | Percentage |
|---|---|---|---|
| Composition C | Composition D | Composition C | Difference |
| 5.24 | 3.63 | 7.79 | 32.80 (C) |
| | | | 53.47 (D) |

### Example 4: Strontium Scale Screening

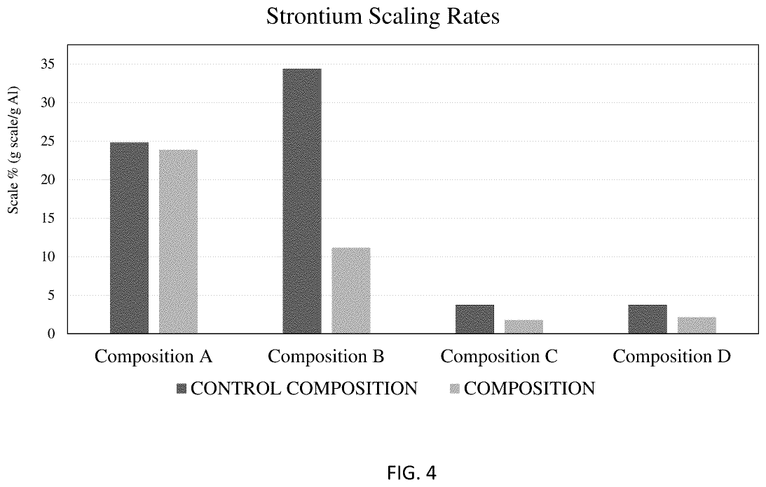

Compositions A through D were introduced at 25 ppm to a 50/50 solution of Brine A and Brine C. Scale testing was completed by suspending two 2″×1″ aluminum 3003-H14 coupons, fabricated from material acquired from McMaster-Carr Supply, into the 50/50 solutions with Compositions A through D. Sample containers were then placed into a laboratory oven at an elevated temperature of 150° C. and continuously monitored with a thermocouple until the sample temperature reached 90° ° C. Once the desired temperature was reached, the samples were removed from the oven and allowed to return to ambient temperature. The coupons were then removed, lightly rinsed, and then allowed to dry in a laboratory incubator for 4 hours. After 4 hours, a final weight was captured and compared against initial weight to determine the amount of scale precipitated onto the coupon surface. The total scaling was measured by comparing initial weight to the final weight of the coupons. Control Compositions A through C were then compared to Compositions A through D, which resulted in various reductions in strontium scaling rates as seen in Table 8 below and FIG. 4.

TABLE 8
25 PPM STRONTIUM SCALING RATES

| | Scale % (g scale/g Al*100) | | |
|---|---|---|---|
| | Control | Composition with | Percentage |
| Composition | Composition | Supramolecular Host | Difference |
| Composition A | 24.82 | 23.88 | 3.75 |
| Composition B | 34.40 | 11.19 | 67.46 |
| Composition C | 3.77 | 1.79 | 52.42 |
| Composition D | 3.77 | 2.15 | 42.97 |

As seen in Tables 5-8, there was a positive impact on reducing the scale rate with the scale inhibitor compositions exhibiting supramolecular host-guest chemistry according to the disclosure. The overall reduction in scale rates seen in FIG. 4 from Table 8 can aid in operating expenses from routine maintenance to costly repairs and help significantly reduce the overall impact (including environmental impact and inhibitor cost) in municipal water treatment facilities, industrial cooling water systems, oil and gas, agriculture, and/or common household facilities, with compositions of the disclosure.

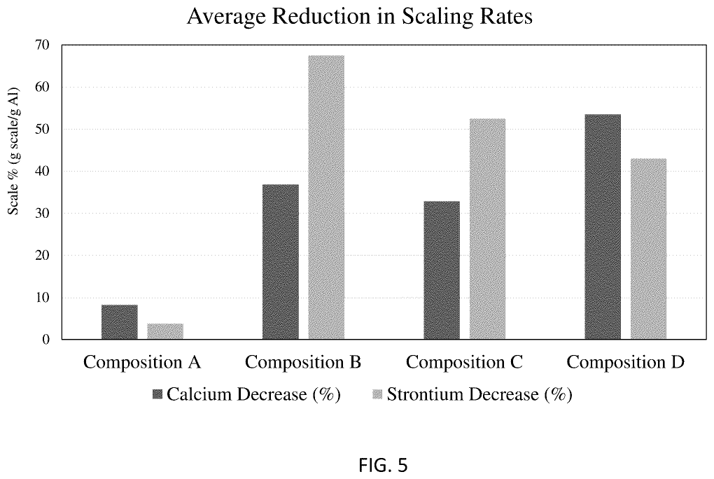

Table 9 provides and FIG. 5 illustrates the average reduction in scale rate.

TABLE 9
AVERAGE REDUCTION IN SCALE RATE

| | Average Reduction in | Average Reduction in |
|---|---|---|
| | Calcium Scale Rate | Strontium Scale Rate |
| Composition | (% ) | (%) |
| Composition A | 8.2 | 3.8 |
| Composition B | 36.8 | 67.5 |
| Composition C | 32.8 | 52.5 |
| Composition D | 53.5 | 43.0 |

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

This following listing of claims is intended to replace all prior listings of claims:

1. A scale inhibitor composition comprising:
a scale inhibitor;
a supramolecular host chemical or a supramolecular guest chemical configured to engage in host-guest chemistry with the scale inhibitor; and
a solvent.

2. The scale inhibitor composition of claim 1, wherein the scale inhibitor comprises an organic scale inhibitor, an inorganic scale inhibitor, or a combination thereof.

3. The scale inhibitor composition of claim 2, wherein the organic scale inhibitor is present and comprises polyacrylic acid, phosphino carboxylic acid, a sulfonated polymer, a phosphonate, a phosphate ester, or any combination thereof.

4. The scale inhibitor composition of claim 2, wherein the inorganic scale inhibitor is present and comprises a condensed phosphate.

5. The scale inhibitor composition of claim 1, which further comprises a pH buffer, a colorant, an adjuvant, a stabilizer, a rheology modifier, or a combination thereof.

6. The scale inhibitor composition of claim 1, wherein the scale inhibitor is present in an amount of about 1 percent to about 90 percent by weight of the composition.

7. The scale inhibitor composition of claim 1, wherein the supramolecular host chemical or supramolecular guest chemical is present in an amount of about 1 percent to about 90 percent by weight of the composition.

8. The scale inhibitor composition of claim 7, wherein the supramolecular host chemical is present and comprises a charge, magnetic properties, or both.

9. The scale inhibitor composition of claim 1, wherein the solvent comprises water.

10. The scale inhibitor composition of claim 1, wherein the solvent is present in an amount of about 0.5 percent to about 80 percent by weight of the composition.

11. A method of preparing the scale inhibitor composition of claim 1, which comprises:
forming a mixture of the solvent and the scale inhibitor; and
adding the supramolecular host chemical or the supramolecular guest chemical to the mixture to form the composition.

12. A method of inhibiting formation of scale on a surface material in contact with a fluid, which comprises:
adding a scale inhibitor composition in an anti-scale inhibiting amount to the fluid, the composition comprising:
a scale inhibitor;
a supramolecular host chemical or a supramolecular guest chemical configured to engage in host-guest chemistry with the scale inhibitor; and
a solvent; and
applying the fluid to the surface material to inhibit scale formation.

13. The method of claim 12, wherein the scale inhibitor composition reduces formation of scale on the surface material by at least about 10%.

14. The method of claim 12, wherein the formation of scale on the surface material is reduced for at least about 24 hours.

15. The method of claim 12, wherein the surface material is selected to comprise a metal.

16. The method of claim 12, wherein the fluid is selected to comprise a brine.

17. The method of claim 12, wherein the scale inhibitor is selected to comprise an organic scale inhibitor, an inorganic scale inhibitor, or a combination thereof.

18. The method of claim 12, wherein the scale inhibitor is present in an amount of about 1 percent to about 90 percent by weight of the composition.

19. The method of claim 12, wherein the supramolecular host chemical or supramolecular guest chemical is added in an amount of about 1 percent to about 90 percent by weight of the composition.

20. The method of claim 12, wherein the supramolecular host chemical is present and selected to comprise a charge, magnetic properties, or both.

21. The method of claim 12, wherein the solvent is selected to comprise water.

22. The method of claim 12, wherein the solvent is added in an amount of about 0.5 percent to about 80 percent by weight of the composition.

23. The method of claim 12, which further comprises applying the fluid to a second surface material.

24. The method of claim 23, which further comprises applying the fluid to a second surface material that is later contacted with a third surface material.
